(19) United States
(12) Patent Application Publication
(10) Pub. No.: US 2006/0120222 A1
(43) Pub. Date: Jun. 8, 2006

(54) Mechanical indicator utilizing circular polarization

(76) Inventor: Michael J. Mazzetti, SAnta Barbara, LA (US)

Correspondence Address: MICHAEL J. MAZZETTI, 1168 PALOMINO ROAD, SANTA BARBARA, CA, 93105, US

(21) Appl. No.: 11/286,978

(22) Filed: Nov. 28, 2005

Related U.S. Application Data
(60) Provisional application No. 60/633,376, filed on Dec. 6, 2004.

(51) Int. Cl. G04C 17/00; G04B 19/00

(52) U.S. Cl. 368/223

(57) ABSTRACT

A mechanical indicating device of novel construction such that hands appear opaque except for selected features of the device face. These selected features, such as timekeeping hour demarcations, date, or minor dial hands, being clearly visible through the major hands. Additional effects can include hidden features revealed only by the hands. The novel construction consisting of circular polarizing material and selectively reflective surfaces on the device face.

### CROSS-REFERENCE

This application relates to Disclosure Document 554537 filed Jun. 3, 2004.

This application relates to Provisional Application 60/633376 filed Dec. 6, 2004.

### FIELD OF INVENTION

The present invention generally relates to indicating dials and hands of special construction for added visual effects and improved readability, particularly of analog timepieces.

### BACKGROUND—PRIOR ART

Analog timepieces, thermometers, speedometers, and gauges are well known in the art. Typically, prior art describes an analog timepiece, comprising a housing, a transparent protective cover (i.e. crystal), at least one mechanical hand, a face plate, and a mechanical and/or electronic timekeeping assembly. Typically, a face contains demarcations of ordinal numbers or graphic symbols, over which at least one mechanical hand rotates to communicate time of day information. Additionally, calendar information may be communicated utilizing a separate mechanical hand or minor dial. A separate window, communicating numeric date information is often incorporated. Such devices routinely obscure view of this additional information with an opaque indicating hand. Functions are rendered useless for minutes or hours at a time.

In comparison, digital indicators or timepieces may include large and clear displays, such as day of the week and month of the year, in written form or abbreviations. Such digital timepieces however, wristwatches in particular, are less appealing to many users, because digital timepieces do not communicate time information in a “graphic” and “instantly perceived” manner as provided by an analog timepiece.

Timepieces combining both analog time representation and digital information typically include displays that are periodically obscured by a mechanical hand or hands. Other approaches position digital displays at separate areas of a device thereby reducing the size of both the digital and the analog portions of the faceplate, compromising readability.

### SUMMARY OF INVENTION

The present invention utilizes circular polarization and its effects to control the visibility of selected features within an indicating device. Light of a particular polarization is blocked from view by a polarizing material while other light is easily visible through this material.

An indicating hand can appear opaque while placed over a spectrally reflective surface (i.e. mirrored) or while over material creating circular polarization of an opposite direction. Objects that reflect or pass light of a different nature become visible. This visible light having random or no polarization, linear polarization, or circular polarization of the same direction as the hand.

The present invention also utilizes quarter-wave-plate material, placed beneath a hand or cover that has circular polarizing properties. This serves to change the property of otherwise blocked light, and cause this light to become visible. The quarter-wave-plate material can therefore reveal features when under the indicating device that are otherwise hidden from view.

Common embodiments of the current invention include timekeeping devices with a plurality of graphic styles and features. Timekeeping hour demarcations such as 1 through 12 are always kept visible through the hands. A hand never obscures digital displays, thereby providing the advantages of both analog and digital techniques. Smaller, minor dial hands within a face can be kept constantly within view regardless of major hand position.

The present invention can communicate a vast amount of information for unexpected applications previously unavailable in current mechanical indicating devices. A timekeeping face is now available for multiple uses without being interfered by, or detracting from, the reading of time. This added information may, for example, include frequency settings of a clock radio, whether of mechanical or digital electronic means.

### DRAWING FIGURES

FIG. 1 is a face view of an analog clock radio with an un-obscured digital display window.

FIG. 2 is a cross sectional view of FIG. 1 showing light rays along distinguishing paths.

FIG. 3 is an analog timepiece with un-obscured minor dials, a date window, and hidden features.

FIG. 4 is a cross sectional view of FIG. 3 showing light rays along distinguishing paths.

FIG. 5 is an analog timepiece with demarcations and hands revealed through a darkened cover.

FIG. 6 is a cross sectional view of FIG. 5 showing light rays along distinguishing paths.

FIG. 7 is a transparent timepiece face with hidden demarcations revealed only by a hand.

FIG. 8 is a cross sectional view of FIG. 7 showing light rays through distinguishing paths.

FIG. 9 is a cross sectional view of FIG. 7 showing an alternate construction.

### REFERENCE NUMERALS IN DRAWINGS

10 Clock radio with a digital display.
12 Spectrally reflective surface.
14 Scattering reflective features.
16 Circularly polarizing minute hand.
18 Circularly polarizing hour hand.
20 Display window quarter-wave-plate.
22 Liquid crystal display (LCD) assembly.
24 Transparent cover.
26 A-D Light rays of visible feature.
28 A-C Light rays of blocked reflection.
30 A-F Light rays of visible LCD.
32 A-B Light rays of visible face.
34 Timepiece with minor dials and date.
36 Hidden feature.
38 Mechanical display window.
40 Minor dial hand.
44 A-F Light rays of un-hidden feature.
46 A-D Light rays of visible minor dial.
50 Timepiece with revealed hands.
52 Blocked spectrally reflective surface.
54 Revealed scattering reflective features.
56 Circularly polarized cover.
58 Quarter-wave-plate major dial hands.
60 Revealed minor dial hand.
62 A-F Light rays of feature through hand.
64 A-F Light rays of revealed hand.
66 A-F Light rays of revealed minor dial.
68 A-B Light rays of blocked face.
70 Timepiece with a transparent face.
72 Circularly polarized face.
74 Circularly polarized minute hand.
76 Circularly polarized second hand.
78 Circularly polarized hour hand.
80 Quarter-wave-plate features.
82 A-D Light rays revealed through hand.
84 A-B Light rays of darkened hand.
86 A-B Light rays of transparent face.
88 A-C Light rays of revealed feature.
90 Linearly polarized face layer.
92 Quarter-wave-plate face layer.
94 A-B Light rays of revealed feature.

### DETAILED DESCRIPTIONS OF PREFERRED EMBODIMENTS

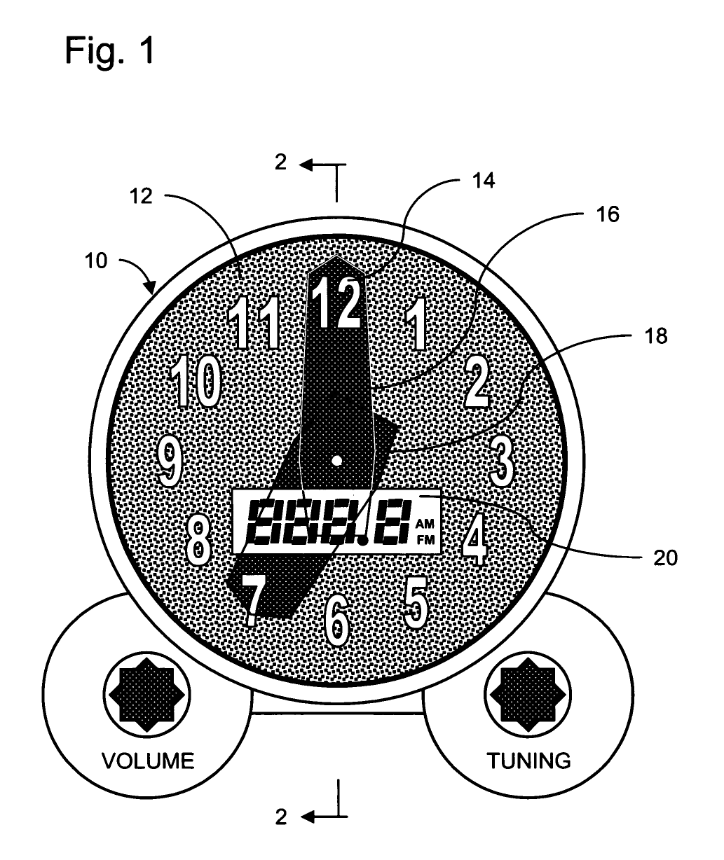

Four suggested embodiments of timekeeping devices are depicted in FIGS. 1 through 9.

FIG. 1 depicts a first embodiment of the present invention in an analog clock radio. A face view of a clock radio with digital display 10 containing a spectrally reflective surface 12 as the face. Placed on this face are hour demarcations as scattering reflective features 14. Placed over this face and features are a circularly polarizing minute hand 16 and a circularly polarizing hour hand 18 that rotate to indicate time of day. A display window quarter-wave-plate 20 within this face provides viewing of digital radio settings. As depicted in this figure, hour demarcations and digital information are not obscured by minute or hour hands. The hands are otherwise darkened when located over the spectrally reflective face.

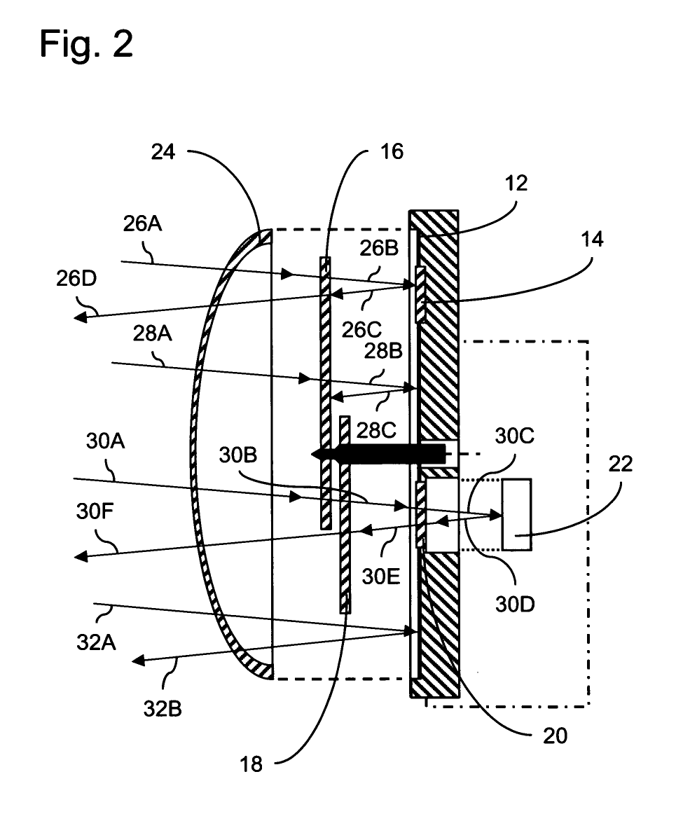

FIG. 2 depicts a cross sectional view of FIG. 1 showing light rays along distinguishing paths. Ambient light of a non-polarized nature forms light ray 26A that passes through transparent cover 24 without change. Upon passing through circularly polarizing minute hand 16, this light becomes a circularly polarized ray 26B. Light striking scattering reflective features 14 again becomes a non-polarized ray 26C which easily passes through hand 16 and cover 24 to become a visible ray 26D. These features therefore maintain visibility through the hand itself.

Another ambient light ray 28A likewise passes through cover 24 and hand 16 becoming a circularly polarized ray 28B. However, this light is reflected by spectrally reflective surface 12 and becomes a ray with circular polarization 28C of a reversed direction from that of ray 28B. Due to it's reversal in direction of polarization, this ray is blocked by hand 16 and is not visible. The hand therefore appears dark to a user while located over this surface.

Another ambient light ray 30A likewise passes through cover 24 and hands 16 and 18 becoming a circularly polarized ray 30B. Passing through a display window quarter-wave-plate 20 converts this light to a linearly polarized ray 30C. This light is processed by liquid crystal display (LCD) assembly 22, as is well know in the art, to create a display of digital information. Light returned from the LCD also forms a linearly polarized ray 30D. Upon passing through window 20, this light is converted to a circularly polarized ray 30E having a same direction of polarization as ray 30B, and that of hand 18. This light, and the digital information associated with it, therefore passes through hand 18 and cover 24 to become visible to a user.

Another non-polarized ambient light ray 32A passes through cover 24 to spectrally reflective surface 12. A reflected light ray 32B passes through transparent cover 24 to become visible, thereby allowing clear view of the timekeeping face.

### DETAILED DESCRIPTIONS OF SECOND EMBODIMENT

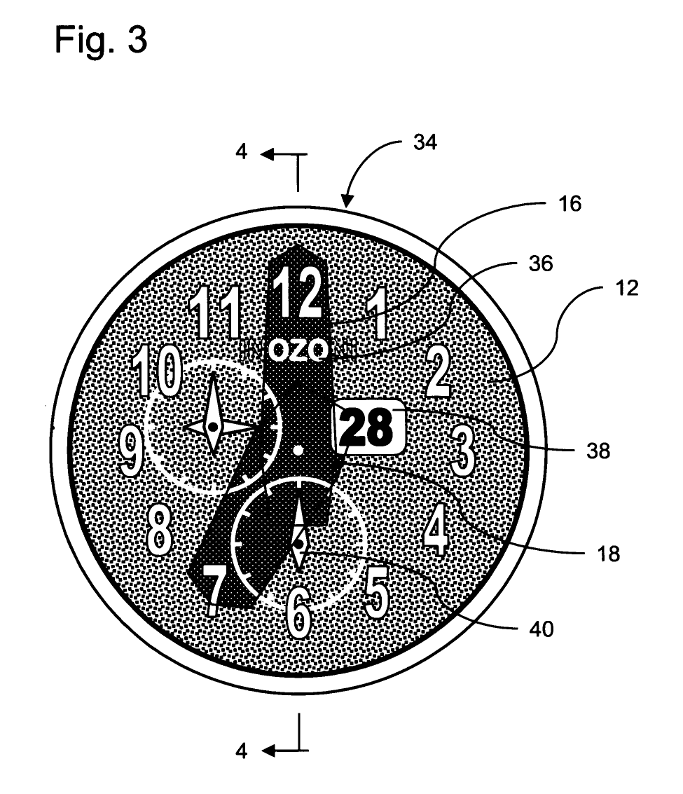

FIG. 3 depicts a second embodiment of the present invention in an analog timepiece with un-obscured minor dials, a date window, and hidden features. A face view of a timepiece with minor dials and date 34 containing a spectrally reflective surface 12 as a face. Placed over this face and features are a circularly polarizing minute hand 16 and a circularly polarizing hour hand 18 that rotate to indicate time of day. A hidden feature 36 forms a brand name logo (i.e. INOZONI) that is partially revealed by the hand 16. A mechanical display window 38 shows current date information that is never obscured by the hands. Minor dial hand 40 resides under the major hands 16 and 18 to indicate seconds of a minute, and is likewise never obscured from view.

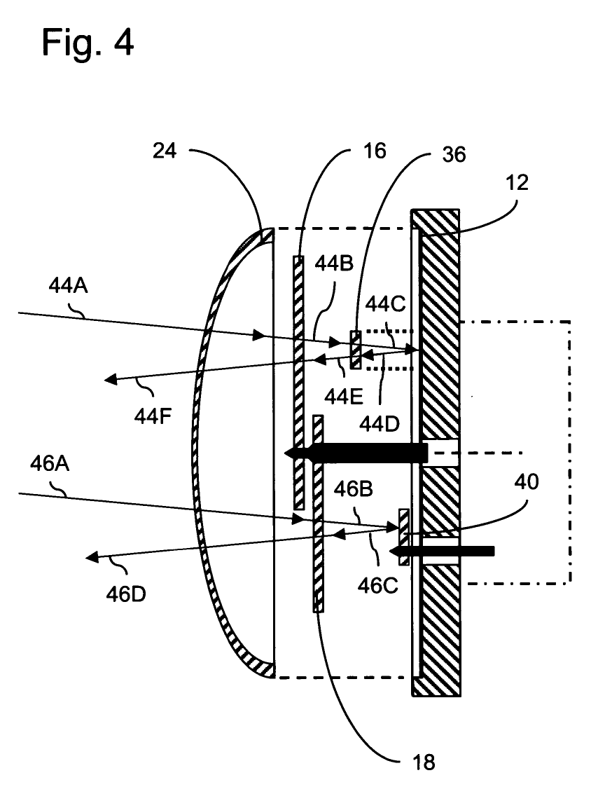

FIG. 4 depicts a cross sectional view of FIG. 3 showing light rays along distinguishing paths. Ambient light of a non-polarized nature forms light ray 44A that passes through transparent cover 24 without change. Upon passing through circularly polarizing minute hand 16, this light becomes circularly polarized ray 44B. This ray then passes through a hidden feature 36 that is constructed of quarter-wave-plate material, thereby converting the light to a linearly polarized ray 44C. Reflection from a spectrally reflective surface 12 of the face creates a linearly polarized ray 44D of the same orientation as ray 44C. This light is then converted back to a circularly polarized ray 44E upon passing through feature 36. Being of the same direction of polarization as the hand 16, ray 44E passes through the hand and cover to become a visible ray 44F. Due to the nature of quarter-wave-plate material being otherwise clear and transparent, hidden feature 36 is not distinguishable from the face itself when observed without a hand.

Another ambient light ray 46A likewise passes through cover 24 and hand 18 becoming a circularly polarized ray 46B. Light striking a scattering reflective surface of minor dial hand 40 again becomes a non-polarized ray 46C which easily passes through hand 18 and cover 24 to become visible ray 46D. Minor dial hands are therefore never obscured by the major hands.

### DETAILED DESCRIPTIONS OF THIRD EMBODIMENT

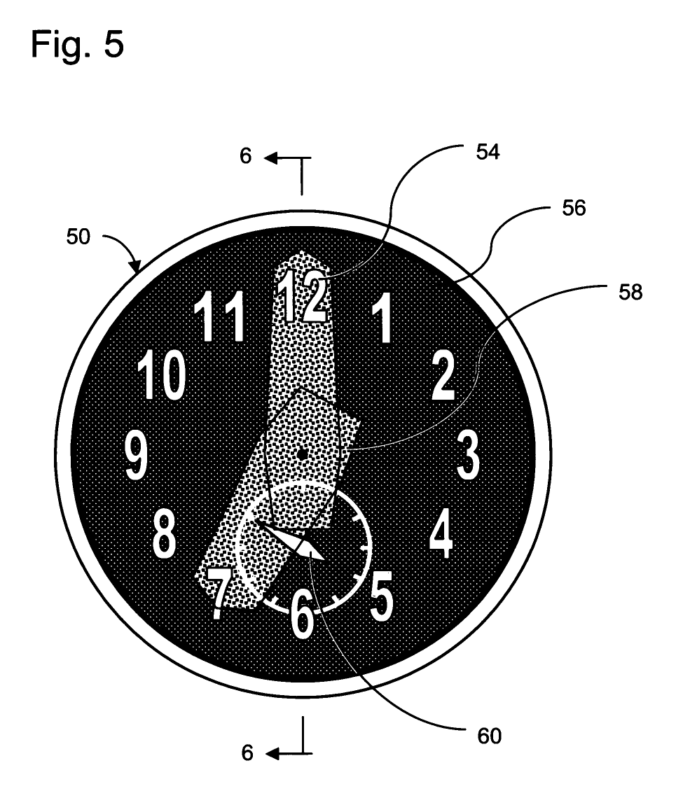

FIG. 5 depicts a third embodiment of the present invention with demarcations and hands revealed through a darkened cover. A timepiece with revealed hands 50 shows a front view of circularly polarized cover 56. Visible through this cover are revealed scattering reflective features 54 and quarter-wave-plate major dial hands 58. These features being visible both through the cover and the hands. Also visible is a revealed minor dial hand 60.

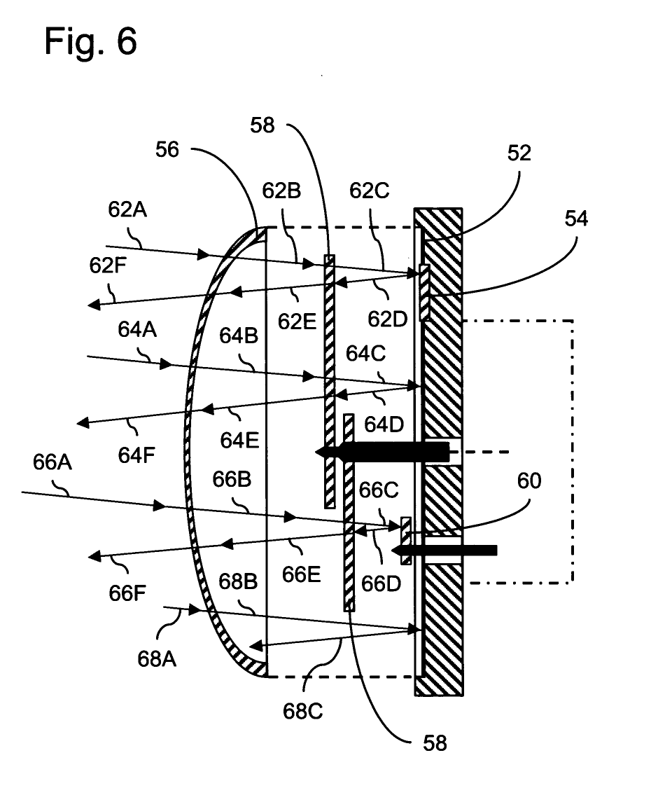

FIG. 6 depicts a cross sectional view of FIG. 5 showing light rays along distinguishing paths. Ambient light of a non-polarized nature forms light ray 62A that passes through a circularly polarized cover 56, becoming a circularly polarized ray 62B. Upon passing through quarter-wave-plate major dial hands 58, this light becomes linearly polarized ray 62C. Revealed scattering reflective features 54 reflect a non-polarized ray 62D back through hand 58. This light is largely unaffected by the quarter-wave-plate material and becomes non-polarized ray 62E. This light continues through the circularly polarized cover 56 to become visible light ray 62F, thereby revealing the feature 54 through the hand itself.

Another ambient light ray 64A likewise passes through circularly polarized cover 56, becoming a circularly polarized ray 64B. Upon passing through quarter-wave-plate major dial hands 58, this light becomes linearly polarized ray 64C. This light is returned by spectrally reflective surface 52 as linearly polarized ray 64D that becomes circularly polarized ray 64E upon passing through quarter-wave-plate major dial hands 58. Light ray 64E, having the same properties of polarization as 64B, passes through circularly polarized cover 56 to become ray 64F and thereby reveal the major dial hand where located over the face surface.

Ambient light ray 66A passes through circularly polarized cover 56 to become a circularly polarized ray 66B. Upon passing through a quarter-wave-plate major dial hands 58, this light becomes linearly polarized ray 66C. Revealed minor dial hand 60 contains a scattering reflective surface that returns non-polarized ray 66D back through hand 58. This light is largely unaffected by the quarter-wave-plate material and becomes non-polarized ray 66E. This light continues through the circularly polarized cover 56 to become visible light ray 66F, thereby revealing the minor dial hand 60 through the major hand itself.

Lastly, ambient light ray 68A passes through circularly polarized cover 56 to become a circularly polarized ray 68B. Upon reflecting from spectrally reflective surface 52, this light becomes a ray 68C having circular polarization of a direction opposite to that of ray 68B. Ray 68C is therefore blocked from view by the circularly polarized cover 56. This action blocks view of the timekeeping face in all areas other than those previously described, making it appear dark.

### DETAILED DESCRIPTIONS OF FOURTH EMBODIMENT

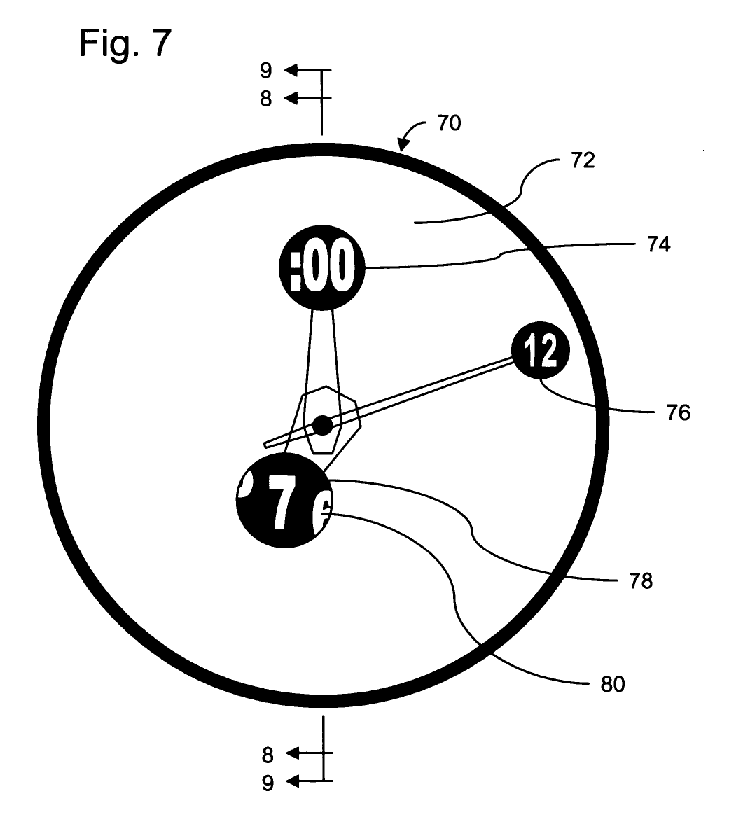

FIG. 7 depicts a fourth embodiment of the present invention with a transparent timepiece having hidden demarcations revealed only by a hand. A timepiece with a transparent face 70 shows circularly polarized minute hand 74, circularly polarized second hand 76, and circularly polarized hour hand 78. These hands constructed of polarizing material, and appearing dark, only at their rounded ends. Otherwise hidden quarter-wave-plate features 80 become visible when located under a passing hand.

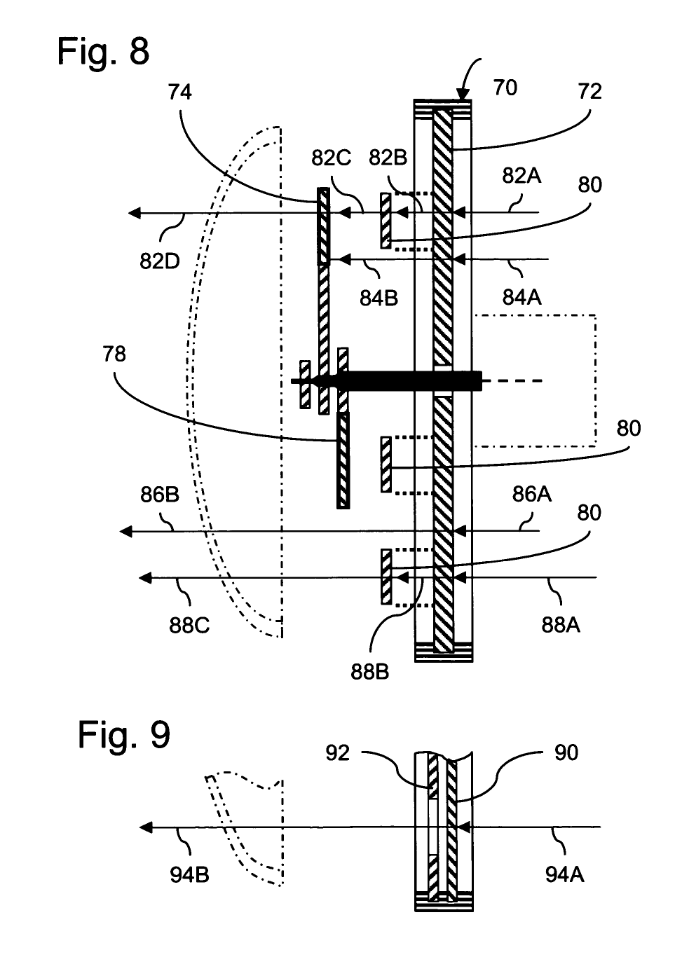

FIG. 8 depicts a cross sectional view of FIG. 7 showing light rays along distinguishing paths. Light originating from ambient light, or artificially generated back lighting, or reflected light, forms a non-polarized ray 82A. Upon passing through a circularly polarized face material 72, this light becomes a circularly polarized ray 82B. This light is converted to a linearly polarized ray 82C by passing through quarter-wave-plate features 80. This light, in turn, passes through a circularly polarized minute hand 74 to become a visible light ray 82B thereby revealing the otherwise hidden feature 80 on the face, only when directly under a hand.

Another non-polarized ray 84A likewise passes through the circularly polarized face 72 to become a circularly polarized ray 84B. This light is subsequently blocked by hand 74 due to the construction of circularly polarized face 72 having a direction of polarization opposite to that of circularly polarized minute hand 74. The hands 74, 76, and 78 therefore appear dark when observed over the face 72.

This face being otherwise transparent to light, as in the case of a non-polarized ray 86A becoming a circularly polarized and visible ray 86B.

Another non-polarized light ray 88A passes through face 72, becoming a circularly polarized ray 88B. This light becomes a linearly polarized ray 88C that is visible and indistinguishable to the human eye from ray 86B, thereby keeping this feature hidden.

FIG. 9 is also a cross sectional view of FIG. 7 showing an alternate construction from that of FIG. 8. In place of a circularly polarized face 72 are two components, a linearly polarized face layer 90 and a quarter-wave-plate face layer 92. As is known in the art, this combination creates a circular polarizer equivalent to face 72 above. This alternate construction creates quarter-wave-plate features by the removal of material from the quarter-wave-plate face layer 92.

A non-polarized light ray 94A passes through linearly polarized face layer 90, becoming a linearly polarized ray 94B thereby having identical properties as light rays 82D and 88C of FIG. 8.

### SUMMARY

Utilization of the polarization of light in mechanical indicating devices creates unique and novel effects. Furthermore, these techniques have the advantages of
Providing an appealing analog representation;
Offering un-obscured views of features within a face surface;
Revealing otherwise hidden features in a novel manner;
Providing the entire face surface for secondary digital displays and mechanical indicators.

It will be apparent to anyone practiced in the art that many variations of these example embodiments are possible. Techniques described herein apply equally to mechanical indicating devices and instruments other than those for timekeeping. Hands and display windows as shown in FIG. 1 may be used for a multitude of functions. The display window may be electronic or mechanical in nature. Many electronic display technologies are applicable including light emitting diodes, organic light emitting diodes, or vacuum florescent displays. Materials for the face, demarcations, and graphic features may present many appearances including a variety of colors, and having smoothly mirrored, textured, patterned, or embossed surfaces.

I claim:

1. A mechanical indicating device comprising at least one hand being opaque to light emanating from the device face while transparent to light from selected features within said face.

2. The device of claim 1 wherein said hand contains polarizing material.

3. The device of claim 1 wherein said face contains spectrally reflective surfaces.

4. The device of claim 1 wherein said face contains scattering reflective surfaces.

5. The device of claim 1 wherein said face contains polarizing material.

6. The device of claim 1 wherein said selected features include timekeeping demarcations selected from the group consisting of hours and minutes and seconds.

7. The device of claim 1 wherein said selected features include at least one minor dial hand.

8. The device of claim 1 wherein said selected features include a display of information selected from the group consisting of an alternate time zone and calendar data and year data and alarm setting data and atmospheric measurement data.

9. The device of claim 1 wherein said selected features include a display of radio settings.

10. The device of claim 1 wherein said selected features include a display of general purpose alphanumeric information.

11. The device of claim 1 wherein said selected features include graphic elements primarily distinguishable only while located beneath said hand.

12. The device of claim 11 wherein said graphic elements contain material selected from the group consisting of one-quarter-wave-plate retarder material and scattering reflective material.

13. The device of claim 1 wherein said selected features include a liquid crystal display.

14. The device of claim 13 wherein said liquid crystal display contains one-quarter-wave-plate retarder material.

15. A mechanical indicating device comprising a cover being opaque to light except for light from selected features located beneath said cover.

16. The device of claim 15 wherein said cover contains polarizing material.

17. The device of claim 15 wherein areas of said cover are made opaque when located over surfaces providing a spectrally reflective surface.

18. The device of claim 15 wherein said selected features contain at least one mechanical hand containing one-quarter-wave-plate retarder material.

19. The device of claim 15 wherein said selected features provide a scattering reflective surface.

20. A mechanical indicating device comprising at least one hand of circular polarizing material and a face of circular polarizing material.
